(19) United States
(12) Patent Application Publication
(10) Pub. No.: US 2025/0061210 A1
(43) Pub. Date: Feb. 20, 2025

(54) DYNAMIC STRUCTURED DATA COMMUNICATIONS

(71) Applicant: Ivanti, Inc., South Jordan, UT (US)

(72) Inventors: Paul Keith Branton, Rochdale (GB); Jens Miltner, Neunkirchen am Brand (DE)

(73) Assignee: Ivanti, Inc., South Jordan, UT (US)

(21) Appl. No.: 18/802,360

(22) Filed: Aug. 13, 2024

Related U.S. Application Data
(60) Provisional application No. 63/519,438, filed on Aug. 14, 2023.

(51) Int. Cl. G06F 21/60

(52) U.S. Cl. CPC G06F 21/602

(57) ABSTRACT

A method of dynamic structured data communication includes registering a structure configured for data communication between applications. The structure includes a structure name and a mapping between data elements and attributes related to the data elements. The structure is registered such that it is accessible to a second application. The method includes receiving encoded data from a first application. The encoded data includes values for the data elements encoded according to the structure and an indication of the structure name. The method includes resolving the encoded data to identify the structure name. Based on the structure name, the method includes accessing the structure and decoding the encoded data according to the accessed structure. The decoding includes generation of a first value that corresponds to a first data element of the encoded data and generated to conform to a first attribute mapped to the first data element in the accessed structure.

### CROSS-REFERENCE TO RELATED APPLICATION

This application claims priority to and the benefit of U.S. Provisional Application No. 63/519,438, filed Aug. 14, 2023, which is incorporated herein by reference in its entirety.

### FIELD

The embodiments described in this disclosure are related to dynamic structured data communication. In particular, some embodiments are related to systems and methods of communicating data encoded according to a registered structure having a mapping between data elements and attributes of the data elements.

### BACKGROUND

Communication between two applications or computing devices in a computing network are often protected using secured protocols. For instance, communication of usernames and passwords between computing devices or between computing processes may be encrypted and/or transmitted in a particular form that obfuscates the data.

To communicate data between the computing devices, a conversion or decoding operation of the data at a receiving computing device may occur. In some conventional systems, a decoder is written for each set of the data communicated between the computing devices. The data communicated is accordingly limited to the written decoder. Changes in the data may accordingly require a revision to the decoder. In some other conventional systems, the receiving computing device assumes attributes associated with the communicated data. For instance, the receiving computing device may assume a datatype of the communicated data. When the data is decoded to get a data value, the receiving device or application assumes the datatype and then converts the transmitted data to that assumed datatype. This process with assumed attributes is error-prone because an incorrect assumption of the datatype results in conversion of the data to an incorrect datatype, which then may result in runtime errors and other processing issues. Accordingly, the receiving computing device fails to accurately receive, convert, and process the communicated data. Moreover, as the number datatypes communicated between computing devices increases, it is more likely that errors in the assumption of the datatype occur.

Accordingly, there is a need in the field of computing networks to provide improved data communication between computing devices. Additionally, there is a need in the field of computing networks to enable a flexible structure in which attributes used in decoding the data can be securely communicated between computing devices.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment may include a method of dynamic structured data communication between a first application and a second application. The method may include registering a structure. The structure may be configured for data communication between the first application and the second application. The structure may include a structure name and a mapping between data elements and attributes related to the data elements. The structure may be registered such that it is accessible to the second application. The method may include receiving encoded data from the first application. The encoded data may include values for the data elements encoded according to the structure. The encoded data may include an indication of the structure name. The method may include resolving the encoded data to identify the structure name. Based on the structure name, the method may include accessing the structure. The method may include decoding the encoded data according to the accessed structure. The decoding may include generation of a first value that corresponds to a first data element of the encoded data. The first value may be generated to conform to a first attribute mapped to the first data element in the accessed structure.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments described in the present disclosure may be implemented;

FIG. 2 is a block diagram depicting a dynamic structured data communication process that may be implemented in the operating environment of FIG. 1;

FIG. 3A depicts an example structure that may be implemented in the process of FIG. 2;

FIG. 3B depicts an example instantiation declaration that may be implemented with the structure of FIG. 3A;

FIG. 3C depicts example data that is encoded according to the structure of FIG. 3A and the instantiation declaration of FIG. 3B;

FIG. 3D depicts an example versioned structure that may be implemented in the process of FIG. 2;

FIG. 3E depicts a second example instantiation declaration that may be implemented with the versioned structure of FIG. 3B;

FIG. 3F depicts example versioned data that is encoded according to the versioned structure of FIG. 3D and the second instantiation declaration of FIG. 3D;

FIG. 3G depicts an example additional structure that may be implemented in the process of FIG. 2;

FIG. 3H depicts an additional example instantiation declaration that may be implemented with the additional structure of FIG. 3F;

FIG. 3I depicts example additional data that is encoded according to the additional structure of FIG. 3G and the additional instantiation declaration of FIG. 3H;

FIG. 4 illustrates an example computer system configured for dynamic structured data communication between applications and computing devices; and

FIG. 5 is a flow chart of an example method of dynamic structured data communication between a first application and a second application,

all according to at least one embodiment described in the present disclosure.

### DESCRIPTION OF SOME EXAMPLE EMBODIMENTS

The embodiments described in this disclosure are related to dynamic structured data communication. In particular, some embodiments are related to systems and methods of communicating data encoded according to a registered structure having a mapping between data elements and attributes of the data elements.

In some operations implemented in computing networks and managed networks, data may be communicated between computing devices or between applications running on one or more of the computing devices. The data may be communicated according to a structure that enables a receiving computing device or a receiving application to accurately decode the data. Some embodiments of the current disclosure describe systems and methods that implement a dynamic structure for data communication. The structure enables dynamic definition of data elements and association of the data elements with attributes such as datatype. The structure may be used to encode and decode the data communicated between the computing devices, between the applications, or data exchanged along any suitable communication channel. In some embodiments, the structure or some portion thereof may be registered at a handler engine. Registration of the structure may associate a structure name with the registered structure. Data may be encoded according to the registered structure and may include the name or identifier. The encoded data may be communicated from a transmitting computing device or application to a receiving computing device or application. The receiving computing device or application may determine the identifier in the encoded data. The identifier may then access the registered structure based on the name or the identifier of the registered structure. The receiving computing device may then decode the received data and decode it according to the registered structure.

Subsequently, the data communicated between the computing devices may change. For instance, additional data may be communicated or a data type of one of the portions of data may change. In these circumstances, the structure may be updated. An updated structure may then be registered at the handler engine with a second name or identifier. Subsequent data communicated between the computing devices may be encoded according to the updated structure. The subsequent data may include the second name or identifier. The subsequent data may be communicated to the receiving computing device or receiving application. The subsequent data may be received and reviewed to determine the second name or identifier. The receiving computing device or receiving application may access the updated structure and the received subsequent data may be decoded according to the updated structure.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

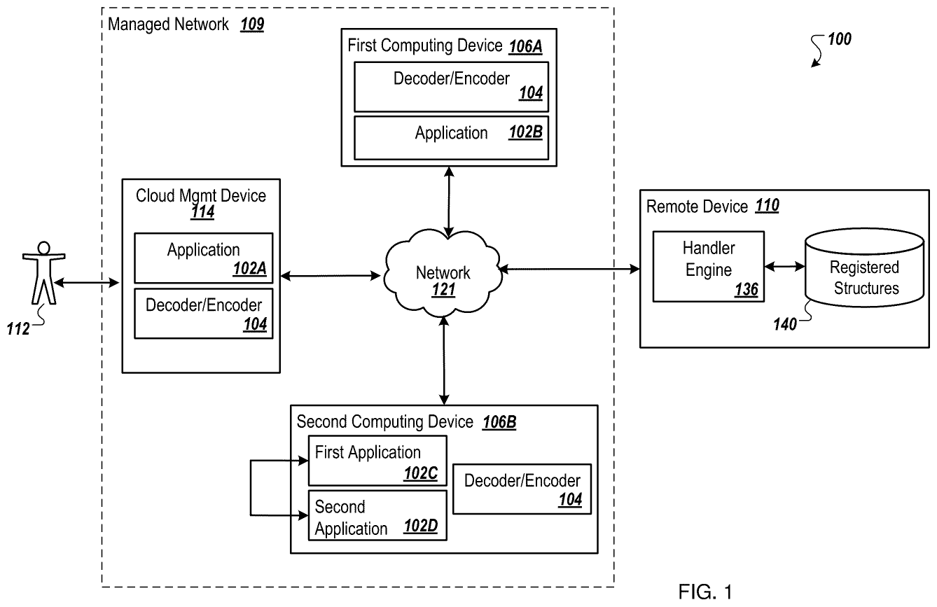

FIG. 1 is a block diagram of an example operating environment 100 in which some embodiments of the present disclosure may be implemented. The operating environment 100 may include a decoder/encoder 104 implemented to handle data communicated between applications 102A-102D (generally, application 102 or applications 102). The decoder/encoders 104 enable generation of structures that may be used to encode and decode data. The structures provide mapping of data elements to attributes of each of the data elements. The structure provides a basis for encoding data prior to communication of the data and a basis by which the data is decoded. The structures also include a structure name and a structure version, which may be included in the encoded data. The structures may be registered at a handler engine 136. After the encoded data is communicated, the application 102 that receives the encoded data reviews the encoded data to identify the structure name and a version. The version may be checked to ensure compatibility. The application 102 may then access the registered structure (e.g., one of the registered structures 140) having the structure name. The application 102 then decodes the encoded data using the accessed structure.

The decoder/encoders 104 enables flexibility in the data communicated between the applications 102. For instance, the structures can include multiple data elements, that can be changed through modifications to the structures. Additionally, the structures enable modification of the attributes of encoded data by updating or modifying structures. Moreover, the structures enable the decoded data to be generated according to one of the attributes of the structures. The structures may accordingly reduce the decoded data that have an incorrect attribute, which may further reduce runtime errors when decoded data is used.

Embodiments of the current disclosure provide an improvement to conventional data communication between applications. For instance, some embodiments enable communication of attributes associated with data, which reduce runtime errors. For instance, in conventional systems the attributes of communicated data are assumed by a receiving application. Accordingly, some data is generated with incorrect attributes such as incorrect datatype, etc. The incorrect attributes may result in runtime errors when the data is used. Moreover, the structures implemented in embodiments of the present disclosure enable modifications to data elements and/or attributes. For instance, communication and registration of additional structures enable such modifications without additional programming at one of the applications 102 receiving the data.

In the embodiment of FIG. 1, the operating environment 100 may include computing devices 106A and 106B, a remote device 110, and the cloud management device 114 (in the Figures, MGMT. device 114) that communicate via a network 121. The network 121 is configured to communicate data and information between the computing devices 106 and the cloud management device 114 and/or between applications 102. Each of the components of the operating environment 100 are introduced in the following paragraphs.

The network 121 may include any communication network configured for communication of signals between the components (e.g., 114 and 106) of the operating environment 100. The network 121 may be wired or wireless. The network 121 may have configurations including a star configuration, a token ring configuration, or another suitable configuration. Furthermore, the network 121 may include a local area network (LAN), a wide area network (WAN) (e.g., the Internet), and/or other interconnected data paths across which multiple devices may communicate. In some embodiments, the network 121 may include a peer-to-peer network. The network 121 may also be coupled to or include portions of a telecommunications network that may enable communication of data in a variety of different communication protocols.

The data communicated in the network 121 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

In the embodiments, the computing devices 106, the cloud management device 114, and the remote device 110 may be included in the managed network 109. The managed network 109 may be implemented to enable management of the computing devices 106 by the cloud management device 114. To implement the managed network 109, the computing devices 106 may be enrolled. After the computing devices 106 are enrolled, ongoing management of the computing devices 106 may be implemented by the cloud management device 114. The ongoing management may include overseeing and dictating at least a part of the operations at the computing devices 106 as described in the present disclosure. For instance, the management device 114 may have authority to make changes (e.g., updates, removal, settings, firewall settings, etc.) to applications 102 on the computing devices 106. The managed network 109 may be associated with an enterprise, a portion of an enterprise, a government entity, or another entity or set of devices (e.g., 114 and 106).

The managed network 109 represents a suitable environment in which some embodiments described herein may be implemented. The embodiments described herein are not limited to the managed network 109. For instance, some embodiments of the structures and communication using the structures may be implemented in any communication channel. For example, some embodiments may be implemented in communication between the first computing device 106A and the second computing device 106B without the management device 114 or between the applications 102C and 102D of the second computing device 106B without the first computing device 106A or the management device 114.

The remote device 110 may include another computing device which may be external to the management device 114 and the computing devices 106. The remote device 110 may be communicatively coupled to the computing devices 106 and the management device 114 via the network 121. In the depicted embodiment, the remote device 110 may host the handler engine 136 and store registered structures 140. The handler engine 136 may be configured to register and enable access to structures. In these and other embodiments, the structures defined for communication of data between the applications 102 may be registered with the handler engine 136 at the remote device 110. Additionally, after data is communicated between the applications 102, the registered structures 140 may be accessed via the handler engine 136 to enable a decode operation using the structures. In the embodiment of FIG. 1, the remote device 110 is not included in the managed network 109. In other embodiments, the remote device 110 may be included in the managed network 109 and may be managed by the management device 114.

Additionally, in some embodiments, the handler engine 136 may be included on one or more or a combination of the computing devices 106 and the management device 114. Additionally or alternatively, the management device 114 may include the handler engine 136 and the registered structures 140.

The computing devices 106 may include hardware-based computer systems that are configured to communicate with the other components of the operating environment 100 via the network 121. The computing devices 106 may include any computer device that may be managed by the cloud management device 114 and/or have been enrolled in the managed network 109. Generally, the computing devices 106 include devices that are operated by the personnel and systems of an enterprise or store data of the enterprise. The computing devices 106 might include workstations of an enterprise, servers, data storage systems, printers, telephones, internet of things (IOT) devices, smart watches, sensors, automobiles, battery charging devices, scanner devices, etc. The computing devices 106 may also include virtual machines, which may include a portion of a single processing unit or one or more portions of multiple processing units, which may be included in multiple machines.

The computing devices 106 and the management device 114 include the applications 102. The applications 102 may include software components, operating systems, or drivers of any kind or type. Some examples of the applications 102 may include software applications, enterprise software, operating systems, etc. that integrate hardware components, plug-ins, services, similar computer-related features or components, or combinations thereof. The applications 102 may differ between the computing devices 106.

The applications 102 might also include an agent. In some embodiments, the management device 114 may interface with the agent. For instance, the agent may have a high level of privilege on the computing device 106, which enables visibility by the agent to one or more other the applications 102 as well as operational parameters related to or characterizing the one or more other applications 102. The agent may be configured to exist on the computing devices 106 to support ongoing management of the computing devices 106.

The cloud management device 114 may include a hardware-based computer system that is configured to communicate with the other components of the operating environment 100 via the network 121. In some embodiments, the cloud management device 114 may be a single server, a set of servers, a virtual device, or a virtual server in a cloud-base network of servers.

The cloud management device 114 may be associated with an administrator 112. The administrator 112 may be an individual, a set of individuals, or a system that interfaces with the cloud management device 114. In some embodiments, the administrator 112 may provide input to the cloud management device 114. The input provided by the administrator 112 may form the basis of some computing processes and operations performed by the cloud management device 114. For example, the administrator 112 may provide user input at a user interface associated with the cloud management device 114 to define structures and input data that is encoded according to a structure.

The management device 114 and/or the computing devices 106 may include the decoder/encoder 104. The decoder/encoder 104 may be configured to handle data packets between two or more of the applications 102. The decoder/encoder 104 enables dynamic output and attribute specifications of the data communicated between the applications 102. For instance, the decoder/encoder 104 may enable definition of structures. The structures provide the data elements and associated attributes for data communicated between the applications 102. For instance, the structures may include a mapping of one or more data elements and one or more attributes of each of the one or more data elements. The structures may further include a structure name, a structure version, and identifiers for the data elements.

In some embodiments, the attributes included in the structure include datatype. Accordingly, the structure defines data elements and associates datatype with each of the data elements. Accordingly, attributes are not included in data communicated between the applications. Instead, the datatype, or the other attributes, are stored in the structure. When decoding the encoded data using the structure, values for each data element are generated according to the datatype of the structure.

Additionally, in some embodiments the data communicated between the applications 102 may be formatted according to JSON. In other embodiments, the structures and the data may be formatted according to YAML, XML, Protobuf, Avro, MongoDB, OData, or another suitable data-interchange format.

The decoder/encoder 104 may enable definition of a structure. For instance, in some embodiments, the administrator 112 may define the structure using the decoder/encoder 104. Additionally or alternatively, the structure may be defined at one or both of the computing devices 106. Definition of the structure may include definition of the data elements and/or definition of attributes that are mapped to the data elements. Additionally, definition of the structure may include defining a structure name, identifiers for the data elements, structure versions, etc.

The decoder/encoder 104 may communicate the structure. For instance, the structure may be communicated from the management device 114 to the first computing device 106A. Additionally, the structure may be communicated from the first computing device 106A to the second computing device 106B. Additionally, the structure may be communicated to the remote device 110 or between applications 102 at a single device (e.g., the second computing device 106B).

The decoder/encoder 104 may register the structure. For instance, the decoder/encoder 104 associated with one of the applications 102 that received the structure may communicate the structure to the handler engine 136. The handler engine 136 may receive the structure and register it. The structure may be registered according to the structure name such that the structure is accessible. The structure may be stored with one or more additional structures, which are designated in FIG. 1 as registered structures 140. The structures may include a structure version. The structure version may designate a version of the structure and or the applications 102. In some embodiments, the structure version may be related to compile time of the structure and may be static. For instance, the structure version may not change at runtime or during communication operations involving the structure.

The decoder/encoder 104 may enable data to be encoded according to the structure. For instance, the structure may include two or more data elements and associated/mapped attributes. The two or more data elements may be associated with identifiers. The data may accordingly be formatted to associate values for each of the data elements with a corresponding identifier. Accordingly, in some embodiments, the data may be formatted as:
data={ . . . “first identifier”:“first value”, “second identifier”:“second value” . . . }
   In this example, the first identifier corresponds to a first data element of the structure and the second identifier corresponds to a second data element of the structure. The data may include the structure name. In some embodiments, the structure name may be included as one of the values of the encoded data. For instance, the structure name may be “first value.”

The encoded data may be received by one of the applications 102. For instance, the encoded data may be received by a second application 102B from a first application 102A or from the decoder/encoder 104 associated with the first application 102A.

The decoder/encoder 104 associated with the application 102 that receives the data may resolve the received data to identify the structure name and the version. The decoder/encoder 104 may determine whether the received structure has been registered and may also verify the version is compatible with the version of the registered structure to ensure compatibility. Based on the structure name, the decoder/encoder 104 may access the structure from the registered structures 140.

The decoder/encoder 104 may decode the data according to the accessed structure. The decoding may include generation of one or more decoded data elements representative of the encoded data. The decoded data elements may be generated based on values of the encoded data. Additionally, the decoded data may format the value of the encoded data to conform to a corresponding attribute from the accessed structure. The application 102 may then use the decoded data in an operation.

The decoder/encoder 104, the handler engine 136, the applications 102, combinations thereof, and components thereof may be implemented using hardware including a processor, a microprocessor (e.g., to perform or control performance of one or more operations), a field-programmable gate array (FPGA), or an application-specific integrated circuit (ASIC). In some other instances, The decoder/encoder 104, the handler engine 136, the applications 102, combinations thereof, and components thereof may be implemented using a combination of hardware and software. Implementation in software may include rapid activation and deactivation of one or more transistors or transistor elements such as may be included in hardware of a computing system (e.g., the computing devices 106 or the cloud management device 114 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 109, one or more cloud management devices 114, one or more computing devices 106, or any combination thereof. Moreover, the separation of various components and devices in the embodiments described herein is not meant to indicate that the separation occurs in all embodiments. Moreover, it may be understood with the benefit of this disclosure that the described components and servers may be integrated together into a single component or server or separated into multiple components or servers.

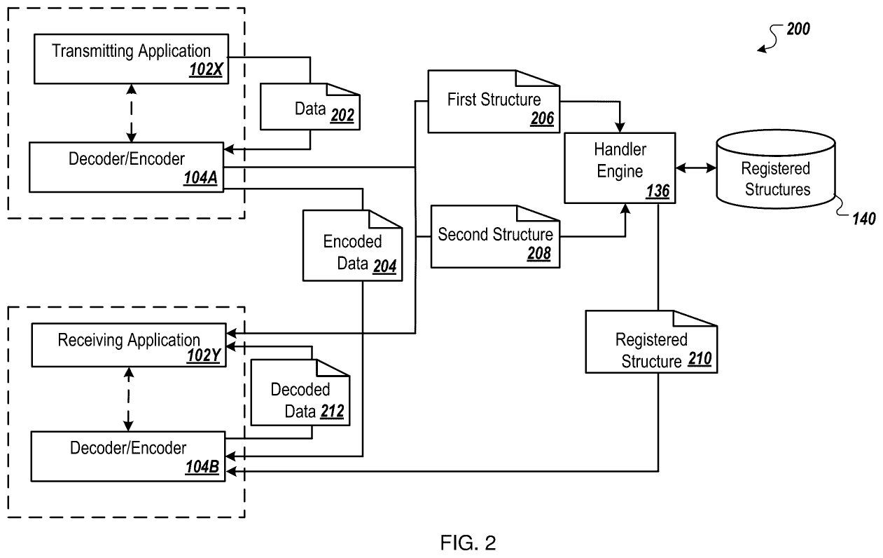

FIG. 2 is a block diagram depicting a dynamic structured data communication process 200 (process 200) that may be implemented in the operating environment 100 of FIG. 1 or another suitable environment. FIG. 2 includes some components (e.g., 136, 140, 104, and 102) described with reference to FIG. 1. Although not depicted in FIG. 2, communication of data and information may be via a communication network such as the network 121.

The process 200 may be implemented to handle data 202 communicated between a transmitting application 102X and a receiving application 102Y. The transmitting and the receiving applications 102X and 102Y are substantially similar to and may correspond to the applications 102 described with reference to FIG. 1. The transmitting application 102X may be associated with a first decoder/encoder 104A. The receiving application 102Y may be associated with a second decoder/encoder 104B. The first and the second decoder/encoder 104A and 104B are examples of the decoder/encoder 104 described with reference to FIG. 1.

Although not depicted in FIG. 2, the transmitting application 102X and the receiving application 102Y may be installed at different computing devices such as the management device 114 and one of the computing devices 106 or at different computing devices 106. Alternatively, the transmitting application 102X and the receiving application 102Y may be installed at one computing device (e.g., the management device 114 or one of the computing devices 106).

The process 200 may begin by a first structure 206 being defined. The first structure 206 may be defined by the transmitting application 102X, the first decoder/encoder 104A, an administrator (e.g., 112 of FIG. 1) associated therewith, or some combination thereof. The first structure 206 may include a mapping of elements of the data 202 to attributes related to the data elements. The attributes related to the data elements of the data 202 may include a characteristic or a property of the related data element. For instance, the attribute may indicate the datatype of a related data element. In addition, the first structure 206 may include identifiers for the data elements, a structure version, and a structure name. The identifiers associate a name with each of the data elements of the data 202. The structure name identifies the first structure 206 relative to other structures which may be registered with the handler engine 136 and/or stored as one of the registered structures 140. The structure version may indicate the version of the structure.

The data 202 may include a set of values. An example of the data 202 may include a password, a username, a role name, branding, credentials, and the like. The transmitting application 102X may implement the first decoder/encoder 104A to encode the data 202 according to the first structure 206.

The first decoder/encoder 104A may be configured to generate encoded data 204. To generate the encoded data 204, the data 202 may be organized according to the mapping of the first structure 206. For instance, the data elements of the data 202 may be designated by the identifiers of the first structure 206. In some embodiments, the encoded data 204 includes the identifiers of the first structure 206 followed by one of the values for the corresponding data element. For instance, the first structure 206 may include a mapping with a first identifier that designates a first element as a “password.” The encoded data 204 may accordingly include the first identifier (e.g., a password) followed by a value of the password from the data 202. Additionally, the encoded data 204 may include the structure name. In some embodiments, the structure name is one of the values of one of the portions of the encoded data 204.

In the process 200, the first structure 206 is registered with the handler engine 136. In some embodiments, the first structure 206 is communicated to the receiving application 102Y, which then registers the first structure 206 with the handler engine 136. In some embodiments, the first decoder/encoder 104A that generated the encoded data 204 or the transmitting application 102X may register the first structure 206 with the handler engine 136. In some embodiments, after the first structure 206 is registered with the handler engine 136, the first structure 206 may be stored as one of the registered structures 140.

The encoded data 204 may be communicated to the receiving application 102Y and/or the second decoder/encoder 104B. The second decoder/encoder 104 may resolve the received encoded data 204 to identify the structure name and a version indicator representative of a version of the encoded data. The resolution may include a first pass through the encoded data. During the resolution, the second decoder/encoder 104 may ignore the remaining portions of the encoded data 204. For instance, during the resolution, decoded data 212 may not be generated.

The second decoder/encoder 104B may determine that the structure of the encoded data 204 is registered based on the structure name. Responsive to the structure not being registered, the encoded data 204 may be rejected. Additionally, the second decoder/encoder 104B may determine version limit compliance. For instance, the second decoder/encoder 104B may check that the version of the encoded data is the version of the registered structure or an earlier version to ensure compatibility between the encoded data and the receiving application 102Y. Responsive to the structure being registered and the version being the structure version or an earlier version, the second decoded/encoder 104B may decode the encoded data 204. Responsive to the structure not being registered or the version being a later version, the second decoded/encoder 104B may reject the encoded data 204.

To decode the encoded data 204, the second decoder/encoder 104B may retrieve or access the first structure 206 based on the structure name that is identified during the resolution. The second decoder/encoder 104B is accessed from the first structure 206 from the handler engine 136 in the depicted embodiment. In some embodiments, the handler engine 136 may communicate a registered structure 210, here the first structure 206, to the second decoder/encoder 104. Such communication may be responsive to a request in some implementations.

The second decoder/encoder 104B may use the accessed registered structure 210 to decode the encoded data 204. For instance, the second decoder/encoder 104 may generate the decoded data 212 based on the encoded data 204 and the accessed registered structure 210.

The registered structure 210, which is the first structure 206, designates identifiers for the data elements of the encoded data 204. For instance, the identifiers may include “password,” “username,” “rolename,” and “branding.” The encoded data 204 may also include the identifiers followed by values for each of the data elements, which are organized according to the identifiers. In addition, in the first structure 206 each of the data elements of the data have associated with it an attribute that describes some characteristic of that data element. For instance, the first structure 206 may include datatypes associated with each of the identifiers/data elements. For instance, the “password” may be a number datatype, the “username” and “rolename” may be string datatypes, and the “branding” may include an array datatype. The second decoder/encoder 104B uses the information related to the data elements when generating the decoded data 212. For instance, when the second decoder/encoder 104B pulls the value for the “password,” the second decoder/encoder 104B may generate the value as a number datatype consistent with the corresponding attribute. Similarly, when the second decoder/encoder 104B pulls the values for the “username” and “rolename,” the second decoder/encoder 104B may generate the values as string datatypes.

The decoded data 212 may be communicated to the receiving application 102Y. The receiving application 102Y may use the decoded data 212 in a process or operation. For instance, the decoded data 212 may include a password and a username of an entity with specific authority needed to execute a secured operation. The receiving application 102Y may enter the decoded data 212 to execute the secured operation.

The process 200 may enable dynamic output and improved flexibility in data communication. In particular, the first structure 206 may be changed to a second structure 208, which may enable additional data, less data, change attributes of the communicated data, etc. Some circumstances that may prompt the change to the second structure 208 may include an additional feature enabled at the receiving application 102Y that involves additional data, changes to security settings at the receiving application 102Y that involves different data, a change in a format of a portion of the data 202 (e.g., a change to password requirements), inclusion of branding or marking information, and the like.

In these and other circumstances, the second structure 208 may be defined. The second structure 208 may include a second structure name, a second structure version, a second mapping, or some combination thereof. The second structure name may be different from the first structure name. Additionally or alternatively, the structure version of the second structure 208 may be different from the structure version of the first structure 206. The second mapping may include at least one data element that is different from the first structure 206 and/or at least one attribute that is different from the first structure 206. The second structure 208 may be registered at the handler engine 136. The data 202 may be encoded according to the second structure 208 to generate the encoded data 204, which is communicated to the second decoder/encoder 104B.

The encoded data 204 includes the second structure name and/or the second structure version, which may be identified during a first pass through the encoded data 204. The second decoder/encoder 104B may access the registered structure 210 based on the identified second structure name. In this circumstance, the registered structure 210 is the second structure 208. The second decoder/encoder 104B may generate the decoded data 212 from the encoded data 204 and the second structure 208. The receiving application 102Y may use the decoded data 212 in a process or operation.

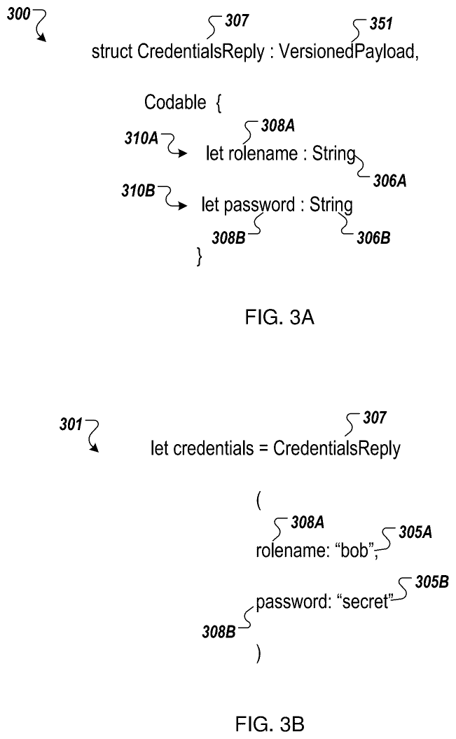

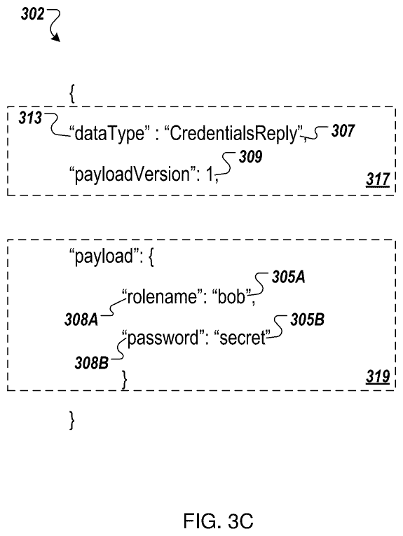

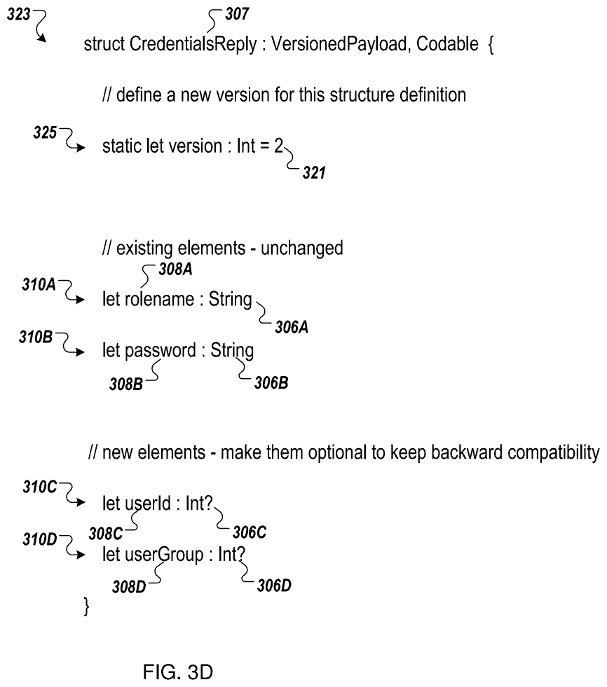

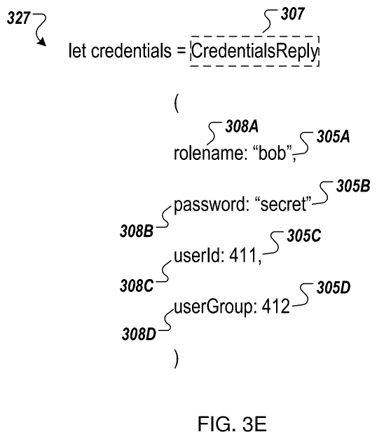

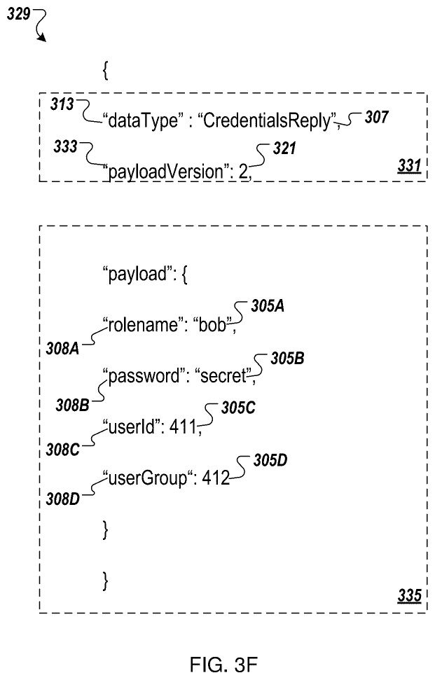

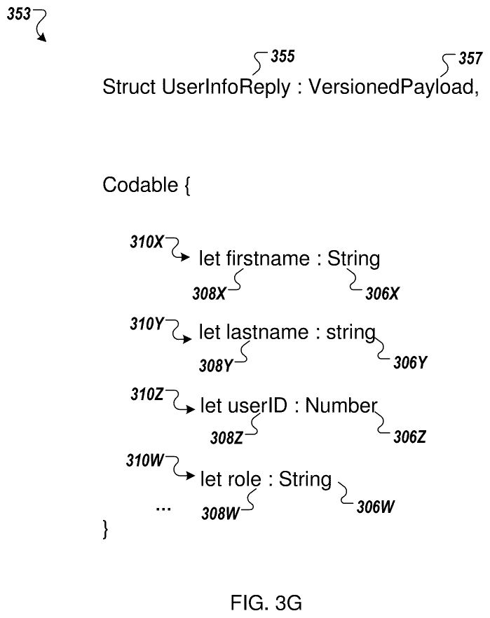

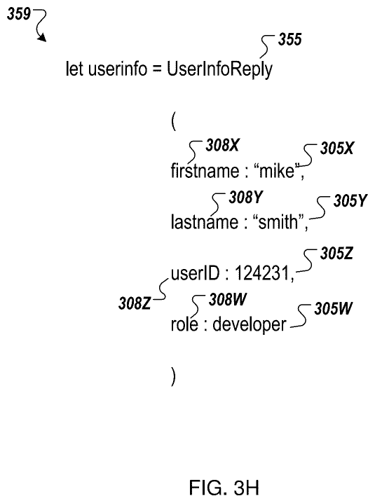

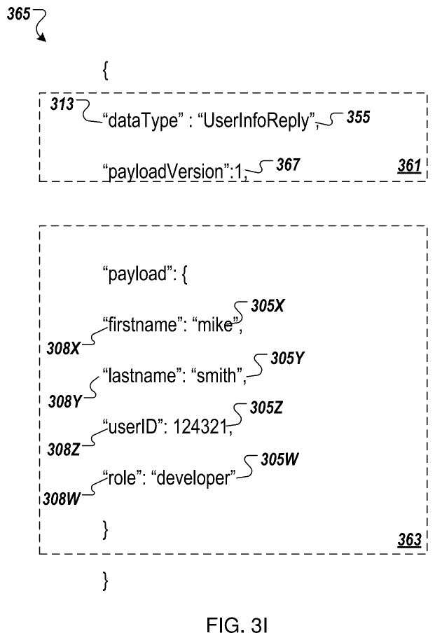

FIG. 3A depicts an example structure 300 that may be implemented in the process 200 of FIG. 2, for instance. The structure 300 is depicted using a Swift® declaration. In other embodiments, the structure 300 may be defined using other similar declarations. The structure 300 includes implicit portions and explicit portions. The implicit portions define parameters of the structure 300 that are static or non-instance values relative to communications that use the structure 300. The implicit portions may be included in metadata. Inclusion of implicit portions in metadata reduces the risk of inserting incorrect metadata or incorrect values for this information. The explicit portions include instance values that may change during communications that use the structure 300. In the structure 300 (and the structures 323 and 353 described below), the implicit portions include a structure name 307 and a version. The explicit portions include data elements 310.

The structure 300 includes the structure name 307 (in FIG. 3A “CredentialsReply”). The structure name 307 enables the structure 300 to be found or accessed following receipt and registration of encoded data such as the data 302 of FIG. 3C that is encoded according to the structure 300. The structure name 307 in the structure 300 follows the identifier “struct” in the structure 300 of FIG. 3A.

The structure name 307 is followed by “VersionedPayload.” In the structure 300, the VersionedPayload protocol defines the version of the structure 300. For instance, the version of the structure 300 may default to a first version or version 1. The version of the structure 300 may be a static value unless it is explicitly overwritten as described with reference to FIGS. 3D-3F.

Additionally, in the structure 300, multiple data elements 310A and 310B (generally, data element 310 or data elements 310) may be listed. Each of the data elements 310 may include an identifier 308A and 308B and an attribute 306A and 306B associated with it. For instance, the structure 300 includes a first data element 310A. The first data element 310A is assigned a first identifier 308A that is “rolename” in FIG. 3A. The first data element 310A further includes a first attribute 306A that includes some parameter or characteristic of the first data element 310A. In the example of FIG. 3A, the first attribute 306A is a datatype for the first data element 310A, which is “string.” Similarly, a second data element 310B includes a second identifier 308B and a second attribute 306B for the second data element 310B. The example of FIG. 3A includes two data elements 310. In some embodiments, the structure 300 may include more than two or less than two data elements 310.

The structure 300 may be communicated to an application or be otherwise registered such that another application may access and use the structure 300 as a basis of decoding data such as the data 302 of FIG. 3C. Additionally details of the registration and use of the structure 300 are described elsewhere in the present disclosure.

FIG. 3B depicts an example instantiation declaration 301 that may be used with the structure 300 of FIG. 3A. The instantiation declaration 301 may be entered by a user of a transmitting application to communicate values 305A and 305B (generally, value 305 or values 305) using the structure 300 of FIG. 3A. For instance, the instantiation declaration 301 may list each of the identifiers 308 with a corresponding one of the values 305. The instantiation declaration 301 may indicate the structure name 307, which may reference the identifiers 308 and enable instantiation of the values 305 into the structure 300.

The instantiation declaration 301 does not include the datatypes for the values 305. The definition of the structure 300 removes this requirement and reduces errors that may result from incorrectly assigning the datatypes to the values 305. Additionally, the version is not included in the instantiation declaration 301. This is carried through to the data 302 by the structure 300. Again, removing this requirement reduces potential errors in data communication.

FIG. 3C depicts example data 302 that is encoded according to the structure 300 of FIG. 3A and the instantiation declaration 301 of FIG. 3B. For instance, the data 302 may include a communication instance using the structure 300. When sending the communication instance using the structure 300 (e.g., via the handler engine 136), a Swift runtime type information may be implemented to form a “requestType.” The requestType may be an implicit value based on the structure name 307. The information in the instantiation declaration may then be encoded using the structure 300 to result in the data 302.

The data 302 may be generated in an envelope format having a first portion 317 and a second portion 319. The first portion 317 may include non-value or static elements and the second portion 319 may include value data elements. For instance, the first portion 317 includes the structure name 307 that is related to a dataType. The dataType may include the implicit values generated when the data 302 is encoded. The first portion 311 may also include a version indicator 309 representative of a version of the encoded data 302. The first portion 311 may be metadata related to the structure 300 and the encoded data 302. Additionally, in some embodiments the first portion 311 may not be visible. For instance, the first portion 311 may not be visible to a user such as an administrator (e.g., 112 of FIG. 1) of the receiving and/or transmitting application.

In some embodiments, when the data 302 is received, a receiving application may resolve the data 302 during a first pass to identify the structure name 307 and to identify the version indicator 309. The receiving application may compare the version of the encoded data 302 that is represented by the version indicator 309 to the version of a registered version. In this example, the version is “1”, which is the default as discussed with reference to FIG. 3A. To decode the data 302, the version of the encoded data 302 may be equal to the version of the registered structure or an earlier version. Additionally, the receiving application may use the structure name 307 to access the structure 300 (e.g., from the handler engine 136). In these and other embodiments, during the first pass to the remaining portions (e.g., the second portion 319) of the data 302 may be ignored.

The second portion 319 includes a payload, which includes the value data elements. For instance, the second portion 319 may include the identifiers 308 and associated values 305. For instance, the data 302 includes the first and the second identifiers 308 from the structure 300. Each of the identifiers 308 is followed by a colon “:” and one of the values 305. The structure 300 and the data 302 are implemented to communicate the values 305 and to communicate attributes of the values 305. To decode the values 305 and ensure the values 305 have the intended attributes, the structure 300 is used. For instance, the first data element 310A (of FIG. 3A), which has assigned the first identifier 308A “rolename” is associated with the first attribute 306A (in FIG. 3A, “string”) in the structure 300. Accordingly, when the data 302 is decoded using the structure 300, a first value 305A “bob” is generated as a string datatype.

FIGS. 3D-3F depict a change to the version of the structure 300 of FIG. 3A. For instance, FIG. 3D depicts a versioned structure 323. FIG. 3E depicts a second instantiation declaration 327 used with the versioned structure 323. FIG. 3F depicts versioned data 329 used with the second instantiation declaration 327 and the versioned structure 323.

Referring to FIG. 3D, the versioned structure 323 includes the structure name 307, which is the same as the structure 300 of FIG. 3A. The versioned structure 323 further includes a version statement 325. The version statement 325 includes a structure version 321 of “2”. Accordingly, the versioned structure 323 includes a version of 2 instead of the default of “1” applied to the structure 300.

Additionally, in the versioned structure 323 includes additional data elements 310C and 310D. The additional data elements 310C and 310D include identifiers 308C and 308D associated with attributes 306C and 306D. These new data elements 310C and 310D are added to the structure 300 of FIG. 3A. In the versioned structure 323, the attributes 306C and 306D are “Int?”. The Int? indicates that these data elements 310 are optional. Making these attributes 306 optional may help ensure backward compatibility with earlier versions of the structure (e.g., the structure 300).

Referring to FIG. 3E, the versioned structure 323 includes the first and second data elements 310A and 310B of the structure 300. In addition, the versioned structure 323 includes a third and a fourth data elements 310C and 310D. Each of the third and the fourth data elements 310 include an identifier 308C and 308D and associated attributes 306C and 306D.

The second instantiation declaration 327 is formatted similarly to the instantiation declaration 301 of FIG. 3B except it includes a third value 305C for the third data element 310C and a fourth value 305D for the fourth data element 310D.

Similar to the instantiation declaration 301, the second instantiation declaration 327 does not include the datatypes for the values 305 or the version. Again, this is carried through to the data 302 by the structure 300. Again, removing this requirement reduces potential errors in data communication.

Referring to FIG. 3F, the versioned data 329 may result from the versioned structure 323 and the second instantiation declaration 327. Similar to the data 302, the versioned data 329 includes a first portion 331 and a second portion 335. The first portion includes a second version indicator 371 that corresponds to the updated value of the structure version 321 in the versioned structure 323. As mentioned elsewhere in the current disclosure, a receiving application may check the compatibility of the version of the registered structure. The receiving application may ensure that the version indicated in the versioned data is the version of a registered structure or an earlier version. For instance, in response to receipt of the versioned data 329, but the structure 300 of FIG. 3A being registered, the versioned data 329 may be rejected because the version indicator 371 is 2, while the version of the structure 300 is 1. However, in response to receipt of the versioned data 329, and the versioned structure 323 being registered, the versioned data 329 may be decoded.

The second portion 335 of the versioned data 329 is similar to the second portion 319 of the data 302. However, the versioned data 329 includes the third and the fourth identifiers 308C and 308D and associated values 305C and 305D. Decoding the versioned data 329 according to the versioned structure 323 generates a third value 305C as an integer (e.g., 306C of FIG. 3D) and a fourth value 305D as an integer (e.g., 306D of FIG. 3D).

FIG. 3G depicts an example additional structure 353. The additional structure 353 may be implemented after the structure 300 of FIG. 3A or the versioned structure 323 of FIG. 3D are registered and/or used to decode the data 302 or the versioned data 329. For instance, the additional structure 353 may be implemented to communicate additional data 365 of FIG. 3I between the applications that were previously communicating using the structure 300 of FIG. 3A.

The additional structure 353 is similar to the structure 300 of FIG. 3A. The additional structure 353 includes an additional structure name 355, in FIG. 3G “CredentialsReply_2”. This separates the additional structure 353 from the structure 300 or the versioned structure 323 that both carry the structure name 307 of “CredentialsReply”. The additional structure 353 includes a default version of 1, similar to the structure 300.

The additional structure 353 includes data elements 310 having identifiers 308 and attributes 306. However, the data elements 310W-310Z of the additional structure 353 are different from those of the structure 300 and the versioned structure 323. As described above, the attributes 306 are associated with the identifiers 308 for each of the data elements 310.

Referring to FIG. 3H, an additional instantiation declaration 359 is depicted. The format of the additional instantiation declaration 359 is similar to the instantiation declaration 301 and the second instantiation declaration 327 except it refers to the identifiers 308W-308Z and provides values 305W-305Z for each of the identifiers 308W-308Z. In addition, the additional instantiation declaration 359 refers to the additional structure name 355.

The additional structure 353 may be communicated to an application or be otherwise registered such that other applications may access and use the additional structure 353 as a basis of decoding data such as additional data 365. In some embodiments, the structure 300, the versioned structure 323, and the additional structure 316 may be concurrently registered with or without one or more additional structures.

Referring to FIG. 3I, the additional data 365 is encoded according to the additional structure 353 and the additional instantiation declaration 359. The additional data 365 is similar to the data 302 of FIG. 3C. For instance, encoding the additional data 365 according to the additional structure 353 is substantially similar to the relationship between the data 302 and the structure 300 discussed with reference to FIGS. 3A-3C. The receiving application may resolve the additional data 365 to identify the additional structure name 355 and the default version identifier. The receiving application may check the version of the additional data 365. The receiving application may access the additional structure 353 based on the additional structure name 355.

The receiving application then uses the additional structure 353 to decode the additional data 365. Decoding the additional data 365 may be substantially similar to the decoding described with reference to FIG. 3A-3G. For instance, the values 305 related to the identifiers 308 are generated as according to the attributes 306 of the additional structure 353.

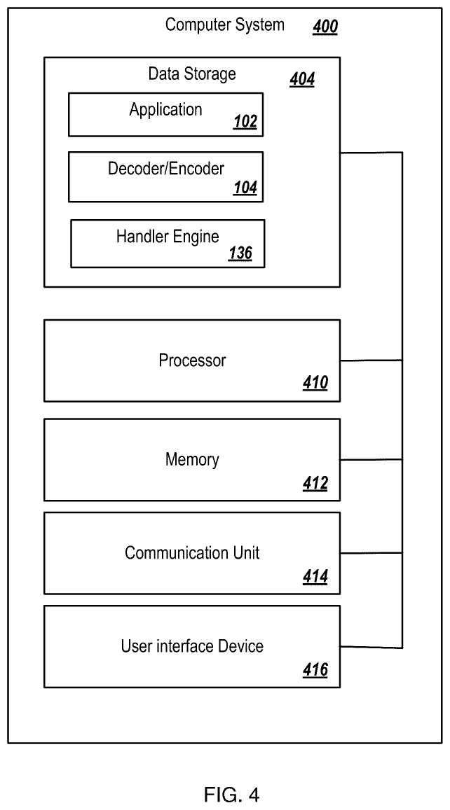

FIG. 4 illustrates an example computer system 400 configured for dynamic structured data communication between applications and computing devices according to at least one embodiment of the present disclosure. The computer system 400 may be implemented in the operating environment 100 of FIG. 1, for instance. Examples of the computer system 400 may include the computing devices 106, the management device 114, the remote device 110, or some combination thereof. The computer system 400 may include one or more processors 410, a memory 412, a communication unit 414, a user interface device 416, and a data storage 402 that includes one or more or a combination of the application(s) 102, the decoder/encoder 104, and the handler engine 136 (collectively, system modules).

The processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 4, the processor 410 may more generally include any number of processors configured to perform individually or collectively any number of operations described in the present disclosure. Additionally, one or more of the processors 410 may be present on one or more different electronic devices or computing systems. In some embodiments, the processor 410 may interpret and/or execute program instructions and/or process data stored in the memory 412, the data storage 402, or the memory 412 and the data storage 402. In some embodiments, the processor 410 may fetch program instructions from the data storage 402 and load the program instructions in the memory 412. After the program instructions are loaded into the memory 412, the processor 410 may execute the program instructions.

The memory 412 and the data storage 402 may include computer-readable storage media for carrying or having computer-executable instructions or data structures stored thereon. Such computer-readable storage media may include any available media that may be accessed by a general-purpose or special-purpose computer, such as the processor 410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

The communication unit 414 may include one or more pieces of hardware configured to receive and send communications. In some embodiments, the communication unit 414 may include one or more of an antenna, a wired port, and modulation/demodulation hardware, among other communication hardware devices. In particular, the communication unit 414 may be configured to receive a communication from outside the computer system 400 and to present the communication to the processor 410 or to send a communication from the processor 410 to another device or network.

The user interface device 416 may include one or more pieces of hardware configured to receive input from and/or provide output to a user. In some embodiments, the user interface device 416 may include one or more of a speaker, a microphone, a display, a keyboard, a touch screen, or a holographic projection, among other hardware devices.

The system modules may include program instructions stored in the data storage 402. The processor 410 may be configured to load the system modules into the memory 412 and execute the system modules. Alternatively, the processor 410 may execute the system modules line-by-line from the data storage 402 without loading them into the memory 412. When executing the system modules, the processor 410 may be configured to perform one or more processes or operations described elsewhere in this disclosure.

Modifications, additions, or omissions may be made to the computer system 400 without departing from the scope of the present disclosure. For example, in some embodiments, the computer system 400 may not include the user interface device 416. In some embodiments, the different components of the computer system 400 may be physically separate and may be communicatively coupled via any suitable mechanism. For example, the data storage 402 may be part of a storage device that is separate from a device, which includes the processor 410, the memory 412, and the communication unit 414, that is communicatively coupled to the storage device. The embodiments described herein may include the use of a special-purpose or general-purpose computer including various computer hardware or software modules.

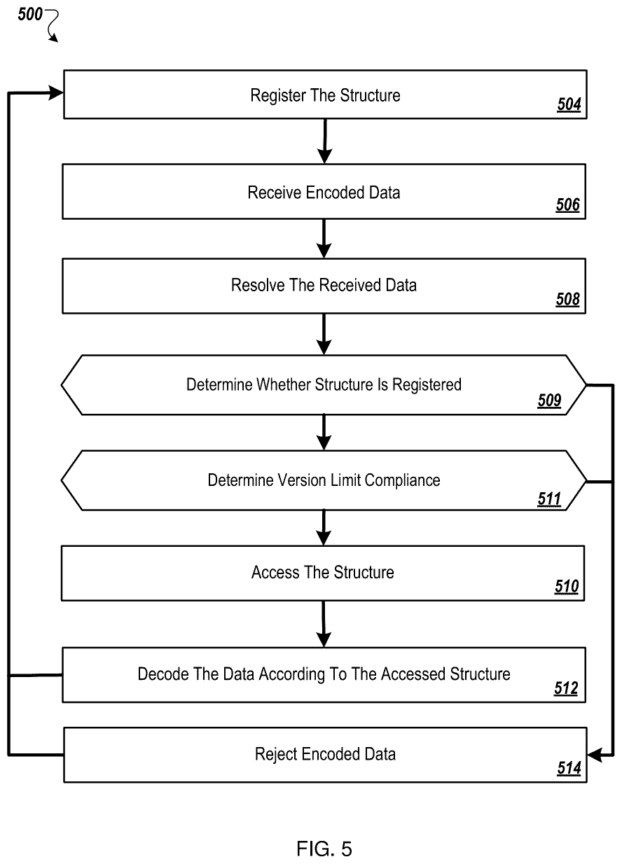

FIG. 5 is a flow chart of an example method 500 of dynamic structured data communication between a first application and a second application, according to at least one embodiment of the present disclosure. The method 500 may enable dynamic output and improved flexibility in data communication. The method 500 may be performed in a suitable operating environment or communication channel such as the operating environment 100 of FIG. 1. One or more operations of the method 500 may be performed by a computing device such as the computer system 400 of FIG. 4, one or both of the computer devices 106, the management device 114, or the application(s) 102 installed thereon. For instance, the method 500 may be implemented between the first application 102A on the management device 114 and the second application 102B of the first computing device 106A. Additionally or alternatively, the method 500 may be implemented between the third application 102C and the fourth application 102D on the second computing device 106B. In some implementations, the applications 102 implementing the method 500 may be the same application or product installed on separate devices (e.g., 102 or 114). Additionally or alternatively, the applications 102 may be different applications or products, which may be installed on the same device or different devices.

The method 500 may begin at block 504, in which the structure may be registered. The structure may be configured for data communication between the first application and a second application. The structure may be defined by the first application or a decoder/encoder associated with the first application. The structure may include a mapping. The mapping correlates data elements with attributes related to the data elements. The attributes of the structure may include datatypes of the data elements in some embodiments. For instance, a first data element may be correlated to a first datatype and a second data element may be correlated to a second datatype. In some embodiments, the structure includes a structure name. The structure name may act as an identifier, which enables retrieval of the structure following registration as described in the following paragraphs. Additionally, in some embodiments, the structure may include structure version. The structure version may be based on a compile time constant that is specified at the first application or the encoder/decoder associated therewith at the time the structure is compiled. The structure version may be static in some implementations.

The structure may be registered such that the structure is accessible to the second application. For instance, the structure may be registered based on the structure name. The structure may be registered at a handler engine in some embodiments. In some embodiments, there may be one structure registered for communication between the first and the second applications. In some embodiments, the structure may be registered at the handler engine with multiple other structures which may be communicated by the first application or other applications.

At block 506, encoded data may be received. The encoded data may be received from the first application after the structure is received and/or registered. The encoded data may be encoded according to the structure and may include one or both of the structure name and a version indicator representative of a version of the encoded data. In some embodiments, the structure name and the version indicator may be included in metadata of the encoded data. For instance, the encoded data may include an envelope format in which the structure name and the version indicator are separate from values of the data elements. In these and other embodiments the structure name and the version indicator may not be visible and the values may be visible.

In addition to the structure name and the version identifier, the encoded data includes the values. In some embodiments, the structure may include a set of identifiers. Each identifier of the set of identifiers is associated with one of the data elements. The data encoded according to the structure references the identifiers and provides a value for each of the data elements. In these and other embodiments, use of the identifiers removes any need to order or sequence the data elements or values in the communicated encoded data. For example, the data elements of the structure may include a username, a password, and a role name. The structure may indicate a first datatype (e.g., string, number, object, array, etc.) is associated with the username, a second datatype is associated with the password, and a third datatype may be associated with the role name. Data encoded according to the structure may include a value for each of the username, the password, and the role name in any order. In some embodiments, the data is formatted according to JavaScript Object Notation (JSON).

At block 506, the received encoded data may be resolved. The received encoded data may be resolved to identify the structure name from the received data. The received encoded data may also be resolved to identify the version identifier from the received data. In some embodiments, resolution may be based on reading and/or interpreting internal metadata. Resolution of the received data to identify the structure name and the version identifier may be a first pass through the received encoded data during which other data elements are ignored.

At block 509, it may be determined whether the structure is registered. For instance, the handler engine may be searched for the structure name. Responsive to the structure name not being registered at the handler engine, it may be determined that the structure is not registered. Responsive to the structure name not being registered (“No” at block 509), the method 500 may proceed to block 514. Responsive to the structure name being registered (“Yes” at block 509), the method 500 may proceed to block 511.

At block 511, compliance with a version limit may be determined. Specifically, it may be determined whether the version indicated the version indicator is either the version of the registered structure or an earlier version. For instance, in some embodiments, the structures and the encoded data are backwards compatible. Accordingly, encoded data from the version of the registered structure or from an earlier version are processable. Responsive to the version being a later version than the structure version (“No” at block 511), the method 500 may proceed to block 514. At block 514, the encoded data may be rejected by the second application. Responsive to the version being equal to the structure version or an earlier version (“Yes” at block 509), the method 500 may proceed to block 510.

At block 510, the structure may be accessed. The structure may be accessed based on the structure name identified during the resolution of the received data. The structure name may enable identification of the registered structure from one or more other structures that have been previously registered.

At block 512, the data may be decoded according to the accessed structure. Decoding the data may include generation of a first decoded value. The first decoded value represents a first value associated with a first data element of the encoded data. The first decoded value is generated to conform to a first attribute mapped to the first data element in the accessed structure. For instance, from the example above, the first data element may include the username. The structure may map the first data element to a string datatype. The encoded data may include, in part, data {username:first_user . . . }. Accordingly, decoding the encoded data according to the accessed structure results in a decoded value for the username (e.g., first_user) being generated to be a string. The remaining data elements are similarly decoded according to the attributes of the structure.

A benefit of the method 500 is the ability to modify the structure, which enables changes to the structure and elements of data communicated between the first and second applications, the attributes, or some combination thereof. For instance, in FIG. 5, from block 512, the method 500 may proceed to block 504 in which an additional structure may be registered. The additional structure may include an additional structure name and an additional mapping between data elements and attributes related to the data elements. The additional structure may include more or fewer data elements than the structure. Additionally or alternatively, the additional structure may have the same number of data elements, but the data elements of the additional structure may be different from the data elements of the structure. In some embodiments, the additional structure may be substantially similar to the structure except the additional structure might include one or more differences in data element number, attribute, identifier, etc. For instance, the additional structure may include an additional structure name and a modified mapping. The modified mapping may be similar to the mapping of the structure except for a single change to a first attribute related to a first data element.

The method 500 may proceed through one or more of blocks 506, 508, 509, 511, 510, 512, and 514 with the additional structure. For instance, additional data may be received from the first application that is encoded according to the additional structure and the additional data may include an indication of the additional structure name (e.g., block 506) and/or an additional version indicator. The received data may be resolved to identify the additional structure name and/or an additional version indicator (e.g., block 508) and the additional structure may be accessed based on the additional structure name (e.g., block 510). The additional data may be decoded according to the accessed additional structure (e.g., block 512).

Further, modifications, additions, or omissions may be made to the method 500 without departing from the scope of the present disclosure. For example, the operations of method 500 may be implemented in differing order. Furthermore, the outlined operations and actions are only provided as examples, and some of the operations and actions may be optional, combined into fewer operations and actions, or expanded into additional operations and actions without detracting from the disclosed embodiments. The designations of different elements in the manner described is meant to help explain concepts described herein and is not limiting. Further, the method 500 may include any number of other elements or may be implemented within other systems or contexts than those described.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of dynamic structured data communication between a first application and a second application, the method comprising:
registering a structure, wherein the structure is defined for data communication between a first application and a second application, the structure includes a structure name and a mapping between data elements and attributes related to the data elements, and the structure is registered such that the structure is accessible to the second application;
receiving, at the second application, encoded data from the first application, wherein the encoded data includes values for the data elements encoded according to the structure and the encoded data includes an indication of the structure name;
resolving the encoded data to identify the structure name;
based on the structure name, accessing the registered structure having the structure name; and
decoding the encoded data according to the accessed structure, wherein the decoding includes generation of a first value that corresponds to a first data element of the encoded data, and the first value is generated such that the first value is formatted according to a first attribute that is mapped to the first data element in the accessed structure.

2. The method of claim 1, further comprising:
receiving from the first application an additional structure, wherein the additional structure includes an additional structure name and an additional mapping between the data elements and the attributes related to the data elements;
registering the additional structure such that the additional structure is accessible to the second application;
receiving additional data from the first application, the additional data that is encoded according to the additional structure and the additional data includes an indication of the additional structure name;
reviewing the received additional data to identify the additional structure name;
based on the additional structure name, accessing the additional structure from a plurality of registered structures that includes both the additional structure and the structure; and
decoding the additional data according to the accessed additional structure.

3. The method of claim 1, wherein:
one of the attributes of the structure includes datatypes of the data elements;
the structure includes an identifier for each of the data elements;
the data encoded according to the structure associates the data elements with the identifiers such that an order of the data does not affect the decoding; and
the data is formatted according to JavaScript Object Notation (JSON).

4. The method of claim 1, wherein:
the structure is registered at a handler engine;
the accessing the structure includes searching the handler engine for the structure name at the handler engine; and responsive to the structure name not being registered at the handler engine, rejecting the encoded data; and
the decoding the encoded data is performed responsive to the structure name being registered at the handler engine.

5. The method of claim 1, wherein:
the structure further includes a structure version associated with the first application or the second application; and
the encoded data includes a version indicator that is representative of a version of the encoded data.

6. The method of claim 5, further comprising:
further resolving the encoded data to identify the version indicator;
determining whether the version indicated by the version indicator is either the version of the registered structure or an earlier version; and
rejecting the encoded data responsive to the version being a later version than the version of the registered structure,
wherein:
the decoding the encoded data is performed responsive to the version indicated the version indicator is either the version of the registered structure or an earlier version; and
the resolving the encoded data is based on internal metadata.

7. The method of claim 5, wherein:
the encoded data is communicated in an envelope format in which the structure name and the version indicator are not visible to a user and values of the encoded data are visible to the user; and
the structure version is based on a compile time of the structure.

8. The method of claim 1, further comprising receiving from the first application an additional structure, wherein:
the additional structure includes an additional structure name and a modified mapping; and
the modified mapping includes the mapping of the structure except for a change to a first attribute related to a first data element of the data elements.

9. The method of claim 1, wherein:
the data elements include a username, a password, and a role name; and
the attributes related to the data elements include a datatype of each of the username, the password, and the role name.

10. The method of claim 1, wherein the first application is different from the second application.

11. The method of claim 1, wherein:
the first application is installed at a first computing device;
the second application is installed at a second computing device;
the first computing device is a management device; and
the second computing device is a device managed by the management device.

12. A non-transitory computer-readable medium having encoded therein programming code executable by one or more processors to perform or control performance of operations of dynamic structured data communication between a first application and a second application, the operations comprising:
registering a structure, wherein the structure is defined for data communication between a first application and a second application, the structure includes a structure name and a mapping between data elements and attributes related to the data elements, and the structure is registered such that the structure is accessible to the second application;
receiving, at the second application, encoded data from the first application, wherein the encoded data includes values for the data elements encoded according to the structure and the encoded data includes an indication of the structure name;
resolving the encoded data to identify the structure name;
based on the structure name, accessing the registered structure having the structure name; and
decoding the encoded data according to the accessed structure, wherein the decoding includes generation of a first value that corresponds to a first data element of the encoded data, and the first value is generated such that the first value is formatted according to a first attribute that is mapped to the first data element in the accessed structure.

13. The non-transitory computer-readable medium of claim 12, wherein the operations further comprise:
receiving from the first application an additional structure, wherein the additional structure includes an additional structure name and an additional mapping between the data elements and the attributes related to the data elements;
registering the additional structure such that the additional structure is accessible to the second application;
receiving additional data from the first application, the additional data that is encoded according to the additional structure and the additional data includes an indication of the additional structure name;
reviewing the received additional data to identify the additional structure name;
based on the additional structure name, accessing the additional structure from a plurality of registered structures that includes both the additional structure and the structure; and
decoding the additional data according to the accessed additional structure.

14. The non-transitory computer-readable medium of claim 12, wherein:
one of the attributes of the structure includes datatypes of the data elements;
the structure includes an identifier for each of the data elements;
the data encoded according to the structure associates the data elements with the identifiers such that an order of the data does not affect the decoding; and
the data is formatted according to JavaScript Object Notation (JSON).

15. The non-transitory computer-readable medium of claim 12, wherein:
the structure is registered at a handler engine;
the accessing the structure includes searching the handler engine for the structure name at the handler engine; and responsive to the structure name not being registered at the handler engine, rejecting the encoded data; and
the decoding the encoded data is performed responsive to the structure name being registered at the handler engine.

16. The non-transitory computer-readable medium of claim 12, wherein:
the structure further includes a structure version associated with the first application or the second application; and
the encoded data includes a version indicator that is representative of a version of the encoded data.

17. The non-transitory computer-readable medium of claim 16, wherein:
the operations further comprise:
further resolving the encoded data to identify the version indicator;
determining whether the version indicated by the version indicator is either the version of the registered structure or an earlier version; and
rejecting the encoded data responsive to the version being a later version than the version of the registered structure;
the decoding the encoded data is performed responsive to the version indicated the version indicator is either the version of the registered structure or an earlier version; and
the resolving the encoded data is based on internal metadata.

18. The non-transitory computer-readable medium of claim 16, wherein:
the encoded data is communicated in an envelope format in which the structure name and the version indicator are not visible to a user and values of the encoded data are visible to the user; and
the structure version is based on a compile time of the structure.

19. The non-transitory computer-readable medium of claim 12, wherein:
the operations further comprise receiving from the first application an additional structure,
the additional structure includes an additional structure name and a modified mapping; and
the modified mapping includes the mapping of the structure except for a change to a first attribute related to a first data element of the data elements.

20. The non-transitory computer-readable medium of claim 12, wherein:
the data elements include a username, a password, and a role name; and
the attributes related to the data elements include a datatype of each of the username, the password, and the role name.
